(19) United States
(12) Patent Application Publication
(10) Pub. No.: US 2007/0075818 A1
(43) Pub. Date: Apr. 5, 2007

(54) Inductive coupler

(76) Inventor: Ake Hansen, Casula (AU)

Correspondence Address: Gauthier & Connors LLP;Suite 2300, 225 Franklin Street, Boston, MA, 02110, US

(21) Appl. No.: 11/525,595

(22) Filed: Sep. 22, 2006

Related U.S. Application Data
(63) Continuation of application No. PCT/SE05/00459, filed on Mar. 29, 2005.

(30) Foreign Application Priority Data
Mar. 25, 2004 (SE) 0400802-5

(51) Int. Cl. H01F 5/00

(52) U.S. Cl. 336/200

(57) ABSTRACT

The present invention relates to a signal coupling/decoupling arrangement for coupling/decoupling a signal onto/from an AC power line. The arrangement comprises: a carrier structure having a first and a second surface, a first conductive layer for a power line having a first winding arranged on said carrier structure; a second conductive layer for signal line having a second winding arranged on said carrier structure; apertures extending from said first surface to second surface; and a first magnetic core part extending in said aperture and contacting a second magnetic core part, said magnetic core parts forming a substantially closed magnetic circuit.

### FIELD OF THE INVENTION

The present invention relates to the field of power line communications, wherein communication signals are distributed over power lines. More specifically, the present invention relates to a novel coupler on printed circuit boards as an efficient inductive coupler arrangement and method for manufacturing the same.

### BACKGROUND OF THE INVENTION

In recent years computer networking has become one of the fastest expanding fields of technology. These are being rapidly built up and span today the industrial, office, and home markets. The networks are built up using both wired and wireless connections. However one problem with the wired connections is that in old buildings it may be difficult and/or expensive to mount new cables for computer networks. Wireless networks are associated with problems like for example limited range, limited throughput, and security problems.

One way of solving the problem associated with wired networks is to use existing power line cabling for communication signals. This is done through a technology named Power Line Communications (PLC). In this technology a high frequency signal is modulated on top of the standard AC voltage power. The communication or data signal is distributed over the power line system and may be read at a different location in a building or the signal may be transmitted between buildings. In this way it is possible to build up for example a broadband network in buildings, to and from buildings, or to and from buildings and centralized gateways.

This may be a solution for electricity suppliers to offer broadband access to residential areas where other broadband technologies do not exist or offer broadband access at a lower cost than other technologies. It may also be a solution for building up networks in the home environment or in buildings where no other possibilities exist for computer network build up. However, the technology is applicable to all environments where computer or data networks are needed.

Using standard power line wiring as the communication medium has the advantages of low cost, easy installation, and being a familiar process in the installation process.

However, one problem associated with using power line wiring is that it is often a noisy environment. A lot of different types of equipment are connected to the wiring and some of these generate a plentitude of noise, for instance from switching transformers, computers, and electrical motors. There is also a difficulty in the fact that this type of wiring has a large attenuation for communication signals at high frequency.

It is therefore of importance to receive a high signal-to-noise (S/N) ratio of the data signal communicated over the power line.

A similar but not exactly the same concept as will be described below for the present invention has been utilized in power conversion systems where magnetic core elements has been mounted on printed circuit boards in order to obtain a better quality coupling between secondary and primary windings. For instance in WO 03/088285 a system for low profile magnetic element is discussed. The magnetic core is mounted in holes in the PCB and windings are formed on the PCB. The solution in this document has a drawback in that only C or I cores may be utilized and the hole system is done for power conversion wherein several windings in series are encircling core legs in order to increase the effectiveness of the transformer.

Another solution is described in U.S. Pat. No. 6,466,454, wherein small inductive magnetic core elements are placed on a PCB in order to be able to locate high frequency switching electronic components close to the core. The core components in this case do not form an optimal magnetic loop since the core components are only apparent in the PCB hole made for this purpose. The core does not extend on both sides of the PCB and do not form a closed loop.

EP 1088673 relates to a network coupler to provide data transmission via two lines and also couple power from the two lines to the users. The two lines are coupled to one terminal of a power supply. The network coupler symmetrically couples the power into and out of both lines. The network coupler couples data symmetrically, differentially and inductively or capacitively to and/or from the two lines. The network coupler terminates the two lines symmetrically. The coupler may comprise a first primary coil connected to the first line, and a second primary coil connected to the second line.

The cited document relates to a network coupler used in data transfer networks, thus it relates to a low voltage DC application. A feed point (+Ub) is arranged for pure galvanic coupling of winding halves (n1). The windings n1 for common mode are in series with the feed current provide an effective flow equal to zero in the core. This avoids saturation. The signal current through the second winding (n2) is differential and provides a closed circuit in the secondary circuit through the first windings n1, which are in series with from the current point of view.

### SUMMARY OF THE INVENTION

It is one objective of the present invention to provide a coupling circuit with minimal attenuation of a communication signal in a power line concept.

Another object with the present invention is to provide a cost efficient and easy production of such a solution.

These and other objects of the present invention are provided for by an arrangement for coupling a signal source to an AC power line using a printed circuit board (PCB) or similar carrier structure with integrated coils and a magnetic core directly attached to a printed circuit board (PCB). The magnetic core may be of a type such as of a rounded type. The core is then made from slightly curved pieces from a core with wider roundness than ordinary standard cores.

In a preferred embodiment, an arrangement for coupling a signal source to an AC power line is provided, such as that a primary and a secondary winding are formed on a printed circuit board (PCB) or similar carrier structure by etching or likewise removing material from a conductive layer or layers on the PCB, and said windings are placed in the vicinity of each other, and a magnetic core is placed in the vicinity of the windings on said printed circuit board.

The magnetic core is mounted in holes formed in the PCB and in order to facilitate the mounting procedure the magnetic core may be divided into two or more pieces and during the mounting process the two or more pieces may be attached to each other.

The two windings may represent an AC power line and a communication line, respectively. Connectors for connecting the AC power line to the arrangement and connectors for connecting a communication signal may be provided.

The PCB may be a multilayer printed circuit board.

In another embodiment a system is provided for similar purposes as described above, the system comprising:
a printed circuit board (PCB);
a primary winding formed in a conductive layer on a PCB;
a secondary winding formed in a conductive layer on a PCB, said secondary winding is formed in the vicinity of said primary winding; and
a magnetic core directly attached to the PCB in the vicinity of said primary and secondary windings.

The system may further comprise an EMI/EMC filter and connectors for connecting the power line and/or communication signal to the system.

The present invention also describes a method for producing an apparatus for similar purposes as described above wherein a primary winding is formed in a conductive layer on a PCB and a secondary winding is formed also in a conductive layer in the same PCB or another PCB later attached to the first PCB. A magnetic core is mounted in holes formed in the PCB or PCB:s and for convenience during installation the core may be provided divided in two or more pieces and during mounting the two or more pieces will be attached to each other in order to form an efficient inductive coupling. The two windings should be formed in such a way that when the apparatus is mounted they should preferably be located in the vicinity of each other and part of the core be surrounded by the two windings.

The method also includes mounting of connectors for connecting to the power line and/or communication signal. The communication signal may be produced by a communication modem connected to connector or directly attached to the communication wiring.

The apparatus or arrangement may be mounted in a housing or casing.

These objectives and other functions and advantages will be apparent from the following detailed description and accompanying drawings.

### BRIEF DESCRIPTION OF THE DRAWINGS

FIG. 1A is a schematic side view over a PCB with windings and a core,

FIG. 1B is a top view of the layout of the inductive coupler integrated in the PCB of FIG. 1A,

FIGS. 2A and 2B show an alternative embodiment of the invention, and

FIG. 3 is a block diagram illustrating an embodiment of an inductive PCB coupler used in a PLC application.

### DETAILED DESCRIPTION OF THE INVENTION

A solution for modulating/demodulating an AC power line with an overlaid communication signal using a low attenuation inductive coupling between the signal source and the AC line is described in the following detailed description. The difference between the present mentioned and above mentioned EP 1085673 is that the present invention operates on AC, high voltage signals and the windings are flowed by AC current. The core thus obtains the net flow and requires special dimension and material for obtaining linear magnetization.

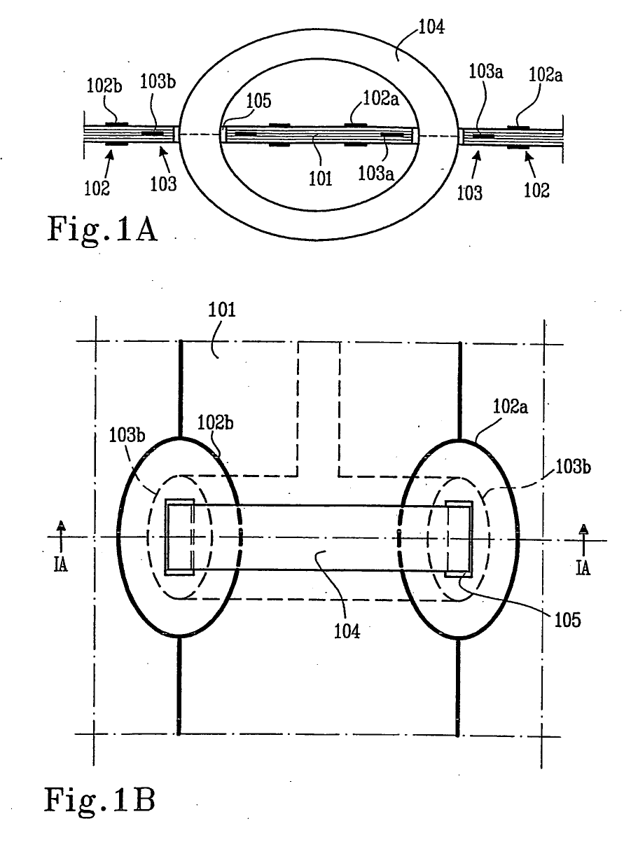

As may be seen in FIGS. 1A and 1B, a PCB 101, or a carrier structure of any type suitable for carrying electric components or conductors, comprises a primary winding 102 and a secondary winding 103. The windings are built up by one or several conductive layers on the PCB. The primary winding 102 comprises first and second spaced apart parts 102a and 102b. The secondary winding 103 comprises first and second spaced apart parts 103a and 103b. The secondary winding 103 may be located inside the primary winding 103 on one or several planes of the PCB 101 using a multilayer PCB or a plurality of PCBS. The PCB further comprises one or several holes or apertures 105 at substantially the center of the two windings 102 and 103. A ferrite (or similar magnetic) core 104 is mounted through the apertures and thus together with the windings providing a coupler/decoupler in order to improve the efficiency of the transformer coupling. This transformer is used to isolate communication signal generating equipment from an AC line and facilitate the overlay of a modulated communication signal on the AC line.

The primary windings 102 are connected to an AC power line and the secondary windings 103 to a signal line.

In the case of FIGS. 1a and 1b, a substantially circular magnetic core 104 is used

In order to mount the magnetic core 104, it is divided into two or more pieces and when mounted on the PCB, the pieces are attached together, e.g. by means of glue or other means. Preferably, the attachment between the core pieces may be in the vicinity of the holes in the PCB for easy installation.

The magnetic core 104 provides an efficient coupling between the two windings as in a normal transformer coupling and therefore the core 104 is preferably mounted on the PCB in such a way that the legs of the core 104 pass through the apertures. The primary 102 and secondary 103 windings preferably surround the core legs in order to provide an efficient inductive coupling. The core may be of ferrite type or any other suitable type as appreciated by the person skilled in the art.

Advantages using this design with an integrated ferrite or other magnetic core on the PCB, with primary and secondary windings are for instance easy and cost efficient production, easy installation, and the result is an efficient transformer coupling between the AC line and the high frequency modulated communication signal.

The primary 102 and secondary 103 windings may be formed on different printed circuit boards and the PCB's may be mounted together in such a way that the two windings are located in close vicinity of each other. The two PCB's may be sandwiched together.

The conductive layer on the PCB may be of any suitable kind but is preferably made of copper, aluminum or similar high electrically conductive material.

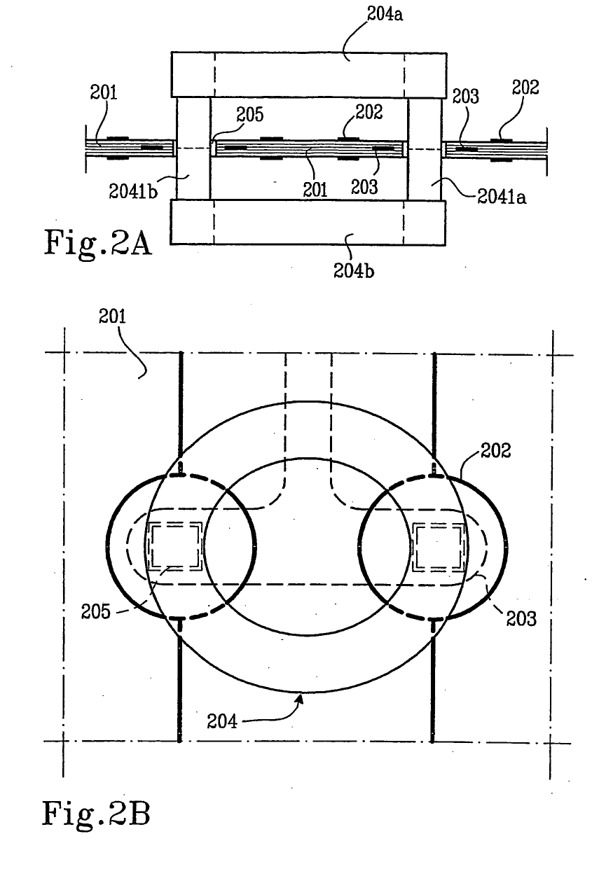

FIGS. 2A and 2B illustrate another embodiment of the invention. In which two substantially circular ferrites 204a and 204b are arranged on different sides of the PCB and attached together by means of attachment pieces 2041a and 2041b. The attachment pieces are made of same material as the core and together with the ferrite comprise the core. Also, this embodiment comprises primary and secondary windings connected to the power line and signal line, respectively.

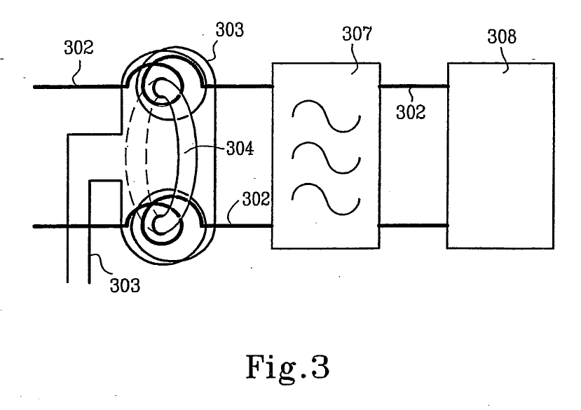

In FIG. 3 an example of an application of a preferred embodiment for a power line communication system is illustrated. A signal line 303 carrying data signals is connected to a secondary winding 303 around a primary winding 302 connected to the power line. The windings are formed on a printed circuit board from a conductive layer. The communication signal is overlaid on to the signal in the primary winding 302, in this case an AC power line. The core 304 mounted on the PCB facilitates the coupling. An optional filter or EMC/EMI shield 307 may be connected to the primary circuit 302 and also an optional capacitor may be mounted between the two lines (phase and neutral) in the primary circuit 302 as illustrated in the schematic block diagram in FIG. 3. The combined AC power voltage and communication signal is then further coupled/decoupled onto/from the power line wiring system 308.

The circuit boards 101, 201 may be used as part of a modem and mounted inside a casing or housing (not shown) for safety and esthetical reasons. This casing may also have a mains attachment, i.e. some connector connecting the device to the power line in a suitable manner, and a communication signal connector including, but not limited to, an Ethernet connector (RJ45 or similar) or USB connector (Universal Serial Bus) for communicating with external equipment including, but not limited to, a personal computer or similar computational device.

The above-described arrangement may also be used in applications where a plurality of sensors are connected to a power line and the sensor signals and measurements are transmitted on the power line to a central information-aggregating device. This may for instance be in an application for automatic remote measurement of power usage in homes or industrial facilities, facilitating the today often manual reading of power meters. The legislation in many countries also directs the attention to such solutions where automatic readings of power meters are of interest.

The modulated communication signal may be generated with standard equipment and techniques as known for the person skilled in the art and not shown in this illustration or discussed in this document. Also any type of frequency modulation scheme may be used. In a power line communication system the modulated communication signal may be provided by a communication modem and the coupling/decoupling arrangement may be incorporated into a communication modem or any other suitable communication device.

In a complete communication system, the coupling/decoupling arrangement is connected to a communication modem, which in turn is connected to a computational device or any other signal generating/consuming device such as, but not limited to, a personal computer, power consumption measuring device, or a household appliance device. The coupling/decoupling arrangement is coupled to a power line through a power line connector conforming to local regulations.

The communication signal may be encrypted and has no bearing on the present invention.

It should be appreciated that the above mentioned embodiments are only for illustrative purposes and should not be limiting to the present invention, but it should be evident that other modifications and variations may be made without departing from the scope of the invention as laid out in the following claims.

1. A signal coupling/decoupling arrangement for coupling/decoupling a signal onto/from an AC power line, that the arrangement comprising:
a carrier structure having a first and a second surface,
a first conductive layer for a power line having a first winding arranged on said carrier structure;
a second conductive layer for signal line having a second winding arranged on said carrier structure;
apertures extending from said first surface to second surface; and
a first magnetic core part extending in said aperture and contacting a second magnetic core part, said magnetic core parts forming a substantially closed magnetic circuit.

2. The arrangement according to claim 1, wherein said carrier structure is a printed circuit board (PCB).

3. The arrangement according to claim 2, wherein said printed circuit board is a multilayer printed circuit board.

4. The arrangement according to claim 1, wherein said second conductive layer is arranged between said first and second surface.

5. The arrangement according to claim 1, wherein said first conductive layer is arranged on said first and/or second surface.

6. The arrangement according to claim 1, wherein said signal is an AC modulated signal.

7. The arrangement according to claim 1, further comprising at least one connector for connecting said communication signal to said second conductive layer.

8. The arrangement according to claim 1, further comprising a power line connector for connecting said power line to said first conductive layer.

9. The arrangement according to, claim 1 being mounted inside a housing.

10. A system for communication of data over an AC power line and comprising:
a coupling/decoupling arrangement comprising:
a first conductive layer for power transmission arranged in a first plane of a carrier structure;
a second conductive layer for signal transmission arranged in a second plane of a carrier structure;
an aperture in said carrier structure or structures;
a portion of said first and second conductive layers surrounding at least partly said aperture; and
a first magnetic core part extending in said aperture and contacting a second magnetic core part, said magnetic core parts forming part of a substantially closed magnetic circuit and
a communication device connected to said coupling/decoupling arrangement.

11. The system according to claim 10, further comprising an EMC/EMI (307) filter arranged in said coupling/decoupling arrangement.

12. The system according to claim 10, further comprising a communication connector.

13. The system according to claim 10, further comprising a power line connector.

14. The system according to claim 10, further comprising a computational device coupled to said communication device.

15. A method for producing an arrangement for an efficient coupling/decoupling of a communication signal onto/from an AC power line, the method comprising the following steps:
forming a first conductive layer for power transmission in a carrier structure in a carrier structure;
forming a second conductive layer for signal transmission in a second plane of a carrier structure;
forming apertures in said carrier structure or structures; and
mounting a first magnetic core part extending in said aperture and contacting a second magnetic core part, said magnetic core parts forming ‘part of a substantially closed magnetic circuit.

16. The method according to claim 15, further comprising the step of forming said second conductive layer in said carrier structure.

17. The method according to claim 15, further comprising the step of forming said first conductive layer externally on said carrier structure.

18. The method according to claim 15, further comprising the step of mounting a communication connector to said second conductive layer.

19. The method according to claim 15, further comprising the step of mounting a power line connector to said first conductive layer.

20. The method according to claim 15, further comprising the step of mounting said arrangement in a housing.

21. A method of enhancing coupling/decoupling of signals to an AC power line, comprising the steps of:
providing a coupling/decoupling arrangement comprising a carrier structure having a first and a second surface, a first conductive layer for a power line having a first winding arranged on said carrier structure, a second conductive layer for signal line having a second winding arranged on said carrier structure, apertures extending from said first surface to second surface; and a first magnetic core part extending in said aperture and contacting a second magnetic core part, said magnetic core parts forming a substantially closed magnetic circuit
transmitting or receiving a modulated signal, indicative of communication signals, on said second conductive layer said modulated signal overlaid on said power line; and
enhancing coupling or decoupling of said signal between said power line and signal line using said magnetic circuit.
